(19) United States
(12) Patent Application Publication
(10) Pub. No.: US 2022/0320636 A1
(43) Pub. Date: Oct. 6, 2022

(54) Battery Adapter Casing

(71) Applicant: Marcos Moreno, Sylmar, CA (US)

(72) Inventor: Marcos Moreno, Sylmar, CA (US)

(21) Appl. No.: 17/219,456

(22) Filed: Mar. 31, 2021

(51) Int. Cl. H01M 50/107; H01M 50/559; H01M 50/244

(52) U.S. Cl. CPC H01M 50/107; H01M 50/559; H01M 50/244

(57) ABSTRACT

Batteries come in many shapes and sizes, yet despite the different sizes, some battery sizes have the same voltage and can be used in place of each other. Therefore, the battery adapter casing may serve as a solution to the size disparity. Smaller sized batteries can fit inside battery casings, which increase their diameter to standard for battery types such as AA, C, and D. Furthermore, several battery casings can be used together, where the battery goes in the casing, and the casing goes in another casing. In addition to different battery types having differently sized diameters, some battery types are not as long as others. Therefore, the negative metal spring can adjust sizes as necessary to fill in the difference of length between the battery used and the battery size desired.

### BACKGROUND

A battery is a device consisting of one or more electrochemical cells with external connections for powering electrical devices such as flashlights, mobile phones, and electric cars. When a battery is supplying electric power, its positive terminal is the cathode and its negative terminal is the anode. The terminal marked negative is the source of electrons that will flow through an external electric circuit to the positive terminal. When a battery is connected to an external electric load, a redox reaction converts high-energy reactants to lower-energy products, and the free-energy difference is delivered to the external circuit as electrical energy. There have been no products available as original equipment or as an aftermarket to address this problem.

Batteries come in many shapes and sizes, from miniature cells used to power hearing aids and wristwatches to small, thin cells used in smartphones, to large lead acid batteries or lithium-ion batteries in vehicles, and at the largest extreme, huge battery banks the size of rooms that provide standby or emergency power for telephone exchanges and computer data centers. Some common consumer battery types are D, C, AAA, and AA. There have been no products available as original equipment or as an aftermarket to address this problem either.

There exists a need for a battery adapter casing that is not being met by any known or disclosed device or system of present.

### SUMMARY OF THE INVENTION

Batteries come in many shapes and sizes, yet despite the different sizes, some battery sizes have the same voltage and can be used in place of each other. Therefore, the battery adapter casing may serve as a solution to the size disparity. Smaller sized batteries can fit inside battery casings, which increase their diameter to standard for battery types such as AA, C, and D. Furthermore, several battery casings can be used together, where the battery goes in the casing, and the casing goes in another casing. This would allow for a AAA battery to be used as a C battery, for example, or for a AA battery to be used as a D battery. In addition to different battery types having differently sized diameters, some battery types are not as long as others. Therefore, the negative metal spring can adjust sizes as necessary to fill in the difference of length between the battery used and the battery size desired.

A battery adapter is disclosed including a battery casing having an outside diameter OD and a thickness T to an inside diameter ID configured to receive a battery of a first standard size and adapt the battery to another standard size via the thickness. The disclosure also includes a terminal extension having an adjustable height from a point adjacent a terminal of the battery to a second point configured to extend a length of the battery first standard size to a respective length of the other standard size, wherein an effective size of the battery received into the battery casing is at least one standard size larger than the battery received therein.

### BRIEF DESCRIPTION OF THE DRAWINGS

FIG. 1 is a view of different types of battery adapter casing in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

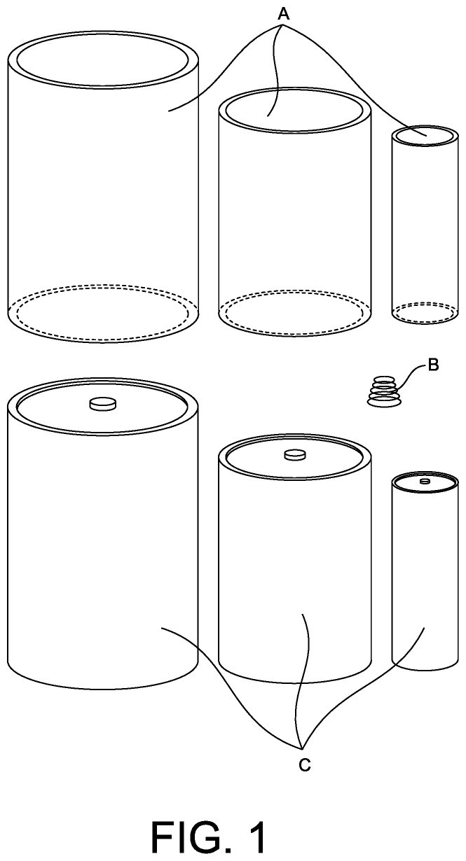

FIG. 1 is a view of different types of battery adapter casing in accordance with an embodiment of the present disclosure. Several casings can be nested to adjust the battery to the desired size. For example, a AAA battery is smaller in diameter than a AA battery, and a AA battery is smaller in diameter than a C battery. Therefore, if a AAA battery is to be used in place of a C battery, it can be fit into the AA casing, then into the C casing. In the view, three casing sleeves A are depicted. These casings are shown adjacent to their matching battery size, D, C, and AA from left to right C. Furthermore, a negative metal spring connection is included and shown B.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A battery adapter comprising:
a battery casing having an outside diameter OD and a thickness T to an inside diameter ID configured to receive a battery of a first standard size and adapt the battery to another standard size via the thickness; and
a terminal extension having an adjustable height from a point adjacent a terminal of the battery to a second point configured to extend a length of the battery first standard size to a respective length of the other standard size.

2. The battery adapter of claim 1, wherein the thickness is an integer multiple of a diameter difference between the battery first standard size and the other standard size.

3. The battery adapter of claim 1, further comprising another battery casing configured to nest the battery casing and the terminal extension to a larger standard size and a longer respective length.

4. The battery adapter of claim 3, further comprising a plurality of nested battery casings to an even larger standard size and an even longer respective length.

5. The battery adapter of claim 1, wherein the terminal extension is a coiled spring for a conduction of electric current.

6. The battery adapter of claim 1, wherein the battery of a first standard size is an AAAA battery and the other standard size is a AAA battery.

7. The battery adapter of claim 1, wherein the battery of a first standard size is an AAA battery and the other standard size is a AAA battery.

8. The battery adapter of claim 1, wherein the battery of a first standard size is an AAA battery and the other standard size is a AA battery.

9. The battery adapter of claim 1, wherein the battery of a first standard size is an AA battery and the other standard size is a C battery.

10. The battery adapter of claim 1, wherein the battery of a first standard size is a C battery and the other standard size is a D battery.

11. The battery adapter of claim 1, wherein the battery casing comprising a stretch material configured to receive a larger standard size battery.

12. The battery adapter of claim 1, wherein the battery casing comprises a semi-enclosed end configured to receive a negative terminal of the battery.

13. The battery adapter of claim 1, wherein the battery casing stretches to receive a standard size 9 volt battery.

14. The battery adapter of claim 1, wherein the battery of a first standard size is an AAAA battery and the other standard size is an AA battery via a plurality of nested battery casings and a respective longer length terminal extension.

15. The battery adapter of claim 1, wherein the battery of a first standard size is an AAAA battery and the other standard size is a C battery via a plurality of nested battery casings and a respective longer length terminal extension.

16. The battery adapter of claim 1, wherein the battery of a first standard size is at least one size smaller than a D standard size and the other standard size is at least one size larger in relation thereto via the battery casing.

17. The battery adapter of claim 1, wherein the battery of a first standard size is at least two sizes smaller than a D standard size.

18. The battery adapter of claim 1, wherein the battery of a first standard size is at least three sizes smaller than a D standard size.

19. The battery adapter of claim 1, wherein the battery of a first standard size is at least four sizes smaller than a D standard size.

20. A battery adapter comprising:
a battery casing having an outside diameter OD and a thickness T to an inside diameter ID configured to receive a battery of a first standard size and adapt the battery to another standard size via the thickness; and
a terminal extension having an adjustable height from a point adjacent a terminal of the battery to a second point configured to extend a length of the battery first standard size to a respective length of the other standard size,
wherein an effective size of the battery received into the battery casing is at least one standard size larger than the battery received therein.
